(19) United States
(12) Patent Application Publication
(10) Pub. No.: US 2021/0172398 A1
(43) Pub. Date: Jun. 10, 2021

(54) REGENERATOR

(71) Applicant: TAMKANG UNIVERSITY, New Taipei City (TW)

(72) Inventors: SHUNG-WEN KANG, Taipei City (TW); PING-MING TU, New Taipei City (TW)

(21) Appl. No.: 16/904,135

(22) Filed: Jun. 17, 2020

(30) Foreign Application Priority Data
Dec. 4, 2019 (TW) 108144205

(51) Int. Cl. F02G 1/057; F25B 9/14

(52) U.S. Cl. CPC F02G 1/057; F25B 9/14

(57) ABSTRACT

A regenerator is provided, which may a hollow pipe body, a first mesh portion, a second mesh portion and a third mesh portion. The first mesh portion may be disposed inside the hollow pipe body and at the rear portion of the hollow pipe body. The second mesh portion may be disposed inside the hollow pipe body and at the central portion of the hollow pipe body, and connected to the first mesh portion. The third mesh section may be disposed inside the hollow pipe body and at the front portion of the hollow pipe body, and connected to the second mesh portion. The mesh number of the first mesh portion, the mesh number of the second mesh portion and the mesh number of the third mesh portion may be increased from the rear portion to the front portion of the hollow pipe body.

### CROSS REFERENCE TO RELATED APPLICATION

All related applications are incorporated by reference. The present application is based on, and claims priority from, Taiwan Application Serial Number 108144205, filed on Dec. 4, 2019, the disclosure of which is hereby incorporated by reference herein in its entirety.

### TECHNICAL FIELD

The technical field relates to a regenerator, in particular to a high-performance regenerator for Stirling cooler.

### BACKGROUND

Stirling coolers adopts reverse Stirling cycle, which is an enclosed gas cycle. A motor in a Stirling cooler drives a piston to compress and inflate the gas. Besides, a displacer is disposed between the hot end and the cold end of the Stirling cooler to make the gas cyclically flows; in addition, a regenerator disposed inside the Stirling cooler can form a high-temperature end and a low-temperature end. Therefore, the regenerator is an important element of Stirling coolers. The purpose of the regenerator is to store and reuse most of the thermal energy provided by the heat source in order to save energy. The temperature of the gas cannot gradually increase or decrease on a gradient basis without the regenerator, so the Stirling cooler should waste more energy to achieve the desired performance.

However, the performance of the currently available regenerators cannot be further improved due to the limits of the structures thereof, so the performance of Stirling coolers also cannot be further enhanced.

Therefore, it has become an important issue to provide a regenerator capable of improving the shortcomings of the currently available regenerators.

### SUMMARY

Therefore, it is a primary objective of the present invention to provide a regenerator so as to solve the shortcomings of the currently available regenerators.

An embodiment of the disclosure relates to a regenerator, which includes a hollow pipe body, a first mesh portion, a second mesh portion and a third mesh portion. The first mesh portion is disposed inside the hollow pipe body and at the rear portion of the hollow pipe body. The second mesh portion is disposed inside and at the central portion of the hollow pipe body, and connected to the first mesh portion. The third mesh portion is disposed inside and at the front portion of the hollow pipe body, and connected to the second mesh portion. The mesh number of the first mesh portion, the mesh number of the second mesh portion and the mesh number of the third mesh portion are increased from the rear portion to the front portion of the hollow pipe body.

In one embodiment, there is a highest common factor M1 of the mesh number of the first mesh portion, the mesh number of the second mesh portion and the mesh number of the third mesh portion.

In one embodiment, the mesh number of the first mesh portion, the mesh number of the second mesh portion and the mesh number of the third mesh portion are increased from the rear portion to the front portion of the hollow pipe body on a basis of an arithmetic sequence E1, wherein the common difference of the arithmetic sequence E1 is the highest common factor M1.

In one embodiment, the difference between the second mesh portion and the mesh number of the first mesh portion is the highest common factor M1, and the difference between the mesh number of the third mesh portion and the mesh number of the second mesh portion is two times the highest common factor M1.

In one embodiment, the difference between the second mesh portion and the mesh number of the first mesh portion is the is two times the highest common factor M1, and the difference between the mesh number of the third mesh portion and the mesh number of the second mesh portion is the highest common factor M1.

In one embodiment, the length of the first mesh portion, the length of the second mesh portion and the length of the third mesh portion are equal.

In one embodiment, there is a highest common factor M2 of the length of the first mesh portion, the length of the second mesh portion and the length of the third mesh portion.

In one embodiment, the length of the first mesh portion, the length of the second mesh portion and the length of the third mesh portion are decreased on a basis of an arithmetic sequence E2.

In one embodiment, the common difference of the arithmetic sequence E2 is the highest common factor M2.

In one embodiment, the length of the first mesh portion is equal to the length of the second mesh portion, and the length of the third mesh portion is the highest common factor M2.

Another embodiment of the disclosure relates to a regenerator, which includes a hollow pipe body, a first mesh portion, a second mesh portion, a third mesh portion and a fourth mesh portion. The first mesh portion is disposed inside the hollow pipe body and at the rear portion of the hollow pipe body. The second mesh portion is disposed inside and at the central portion of the hollow pipe body, and connected to the first mesh portion. The third mesh portion is disposed inside and at the central portion of the hollow pipe body, and connected to the second mesh portion. The fourth mesh portion is disposed inside and at the front portion of the hollow pipe body, and connected to the third mesh portion. The mesh number of the first mesh portion, the mesh number of the second mesh portion, the mesh number of the third mesh portion and the mesh number of the fourth mesh portion are increased from the rear portion to the front portion of the hollow pipe body.

In one embodiment, there is a highest common factor M3 of the mesh number of the first mesh portion, the mesh number of the second mesh portion, the mesh number of the third mesh portion and the mesh number of the fourth mesh portion.

In one embodiment, the mesh number of the first mesh portion, the mesh number of the second mesh portion, the mesh number of the third mesh portion and the mesh number of the fourth mesh portion are increased from the rear portion to the front portion of the hollow pipe body on a basis of an arithmetic sequence E3; the common difference of the arithmetic sequence E3 is the highest common factor M3.

In one embodiment, the difference between the second mesh portion and the mesh number of the first mesh portion is the highest common factor M3, the difference between the mesh number of the third mesh portion and the mesh number of the second mesh portion is the highest common factor M3, and the difference between the mesh number of the fourth mesh portion and the mesh number of the third mesh portion is two times the highest common factor M3.

In one embodiment, the difference between the second mesh portion and the mesh number of the first mesh portion is the highest common factor M3, the difference between the mesh number of the third mesh portion and the mesh number of the second mesh portion is two times the highest common factor M3, and the difference between the mesh number of the fourth mesh portion and the mesh number of the third mesh portion is the highest common factor M3.

In one embodiment, the length of the first mesh portion, the length of the second mesh portion, the length of the third mesh portion and the length of the fourth mesh portion are equal.

In one embodiment, wherein there is a highest common factor M4 of the length of the first mesh portion, the length of the second mesh portion, the length of the third mesh portion and the length of the fourth mesh portion.

In one embodiment, the difference between the length of the second mesh portion and the length of the first mesh portion is the highest common factor M4, and the length of the second mesh portion, the length of the third mesh portion and the length of the fourth mesh portion are equal.

In one embodiment, the length of the second mesh portion and the length of the first mesh portion are equal, the difference between the length of the third mesh portion and the length of the second mesh portion is the highest common factor M4, and the difference between the length of the fourth mesh portion and the length of the third mesh portion is the highest common factor M4.

In one embodiment, the difference between the length of the second mesh portion and the length of the first mesh portion is two times the highest common factor M4, the length of the third mesh portion and the length of the second mesh portion are equal, and the difference between the length of the fourth mesh portion and the length of the third mesh portion is the highest common factor M4.

As described above, the regenerator in accordance with the embodiments of the disclosure has the following advantages:

(1) In one embodiment of the disclosure, the regenerator includes multiple mesh portions and these mesh portions have a special gradient mesh structure, which can significantly improve the coefficient of performance (COP) and the maximal flow velocity of the regenerator, so the performance of the regenerator can be enhanced.

(2) In one embodiment of the disclosure, the regenerator includes multiple mesh portions and the lengths of the mesh portions are specially designed, which can further improve the coefficient of performance and the maximal flow velocity of the regenerator, so the performance of the regenerator can be further enhanced.

(3) In one embodiment of the disclosure, the coefficient of performance and the maximal flow velocity of the regenerator can be dramatically improved, so the performance of the Stirling cooler adopting the regenerator can be also effectively improved.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The disclosure will become more fully understood from the detailed description given herein below and the accompanying drawings which are given by way of illustration only, and thus are not limitative of the disclosure and wherein:

FIG. 1 is a stereoscopic view of a regenerator in accordance with a first embodiment of the disclosure.

FIG. 2 is a sectional view of the regenerator in accordance with the first embodiment of the disclosure.

FIG. 3 is a stereoscopic view of a regenerator in accordance with a second embodiment of the disclosure.

FIG. 4 is a sectional view of the regenerator in accordance with the second embodiment of the disclosure.

FIG. 5 is a simulation result of maximal flow velocity of a regenerator in accordance with a third embodiment of the disclosure.

FIG. 6 is a simulation result of coefficient of performance of the regenerator in accordance with the third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

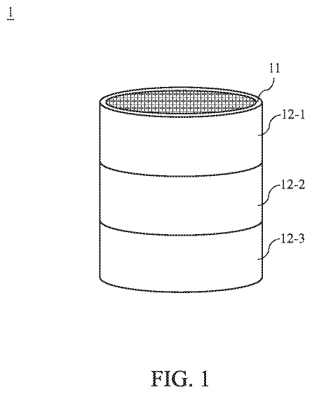

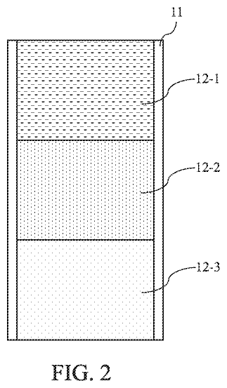

Please refer to FIG. 1 and FIG. 2, which are a stereoscopic view and a sectional view of a regenerator in accordance with a first embodiment of the disclosure respectively. As shown in FIG. 1, the regenerator 1 includes a hollow pipe body 11, a first mesh portion 12-1, a second mesh portion 12-2 and a third mesh portion 12-3. In the embodiment, the inside diameter of the hollow pipe body 11 is 5 mm and the outside diameter of the hollow pipe body 11 is 6 mm. In another embodiment, the inside diameter and the outside diameter of the hollow pipe body 11 can be designed according to actual requirements.

As shown in FIG. 2, the first mesh portion 12-1 may be disposed inside the hollow pipe body 11 and at the rear portion of the hollow pipe body 11.

The second mesh portion 12-2 may be disposed inside the hollow pipe body 11 and at the central portion of the hollow pipe body 11 and connected to the first mesh portion 12-1.

The third mesh portion 12-3 may be disposed inside the hollow pipe body 11 and at the front portion of the hollow pipe body 11 and connected to the second mesh portion 12-2.

More specifically, the mesh number of the first mesh portion 12-1, the mesh number of the second mesh portion 12-2 and the mesh number of the third mesh portion 12-3 are increased from the rear portion of the hollow pipe body 11 to the front portion thereof. Besides, there is a highest common factor M1 of the mesh number of the first mesh portion 12-1, the mesh number of the second mesh portion 12-2 and the mesh number of the third mesh portion 12-3. In the embodiment, the highest common factor M1 is 50. In another embodiment, the highest common factor M1 may be other values (e.g. 25, 100 . . . ).

In the embodiment, the mesh number of the first mesh portion 12-1, the mesh number of the second mesh portion 12-2 and the mesh number of the third mesh portion 12-3 are increased from the rear portion of the hollow pipe body 11 to the front portion of the hollow pipe body 11 on a basis of an arithmetic sequence E1; the common difference of the arithmetic sequence E1 is the highest common factor M1. For example, the mesh number of the first mesh portion 12-1 is 200; the mesh number of the second mesh portion 12-2 is 250; the mesh number of the third mesh portion 12-3 is 300 (the highest common factor M1 is 50).

In another embodiment, the difference between the second mesh portion 12-2 and the mesh number of the first mesh portion 12-1 is the highest common factor M1. The difference between the mesh number of the third mesh portion 12-3 and the mesh number of the second mesh portion 12-2 is two times the highest common factor M1. For instance, the mesh number of the first mesh portion 12-1 is 250; the mesh number of the second mesh portion 12-2 is 300; the mesh number of the third mesh portion 12-3 is 400 (the highest common factor M1 is 50).

In still another embodiment, the difference between the second mesh portion 12-2 and the mesh number of the first mesh portion 12-1 is two times the highest common factor M1. The difference between the mesh number of the third mesh portion 12-3 and the mesh number of the second mesh portion 12-2 is the highest common factor M1. For instance, the mesh number of the first mesh portion 12-1 is 300; the mesh number of the second mesh portion 12-2 is 400; the mesh number of the third mesh portion 12-3 is 450 (the highest common factor M1 is 50).

There is a highest common factor M2 of the length of the first mesh portion 12-1, the length of the second mesh portion 12-2 and the length of the third mesh portion 12-3. In the embodiment, the highest common factor M2 is 5 mm. In another embodiment, the highest common factor M2 may be other values (e.g. 10 mm, 15 mm . . . ).

In the embodiment, the length of the first mesh portion 12-1, the length of the second mesh portion 12-2 and the length of the third mesh portion 12-3 are equal. For instance, the length of the first mesh portion 12-1, the length of the second mesh portion 12-2 and the length of the third mesh portion 12-3 are 15 mm (the highest common factor M2 is 5 mm).

In another embodiment, the length of the first mesh portion 12-1, the length of the second mesh portion 12-2 and the length of the third mesh portion 12-3 are decreased on a basis of an arithmetic sequence E2; the common difference of the arithmetic sequence E2 is the highest common factor M2. For instance, the length of the first mesh portion 12-1 is 20 mm; the length of the second mesh portion 12-2 is 15 mm; the length of the third mesh portion 12-3 is 10 mm (the highest common factor M2 is 5 mm).

In still another embodiment, the length of the first mesh portion 12-1 is equal to the length of the second mesh portion 12-2 and the length of the third mesh portion 12-3 is the highest common factor M2. For example, the length of the first mesh portion 12-1 and the length of the second mesh portion 12-2 are 20 mm; the length of the third mesh portion 12-3 is 5 mm (the highest common factor M2 is 5 mm).

As described above, the regenerator 1 of the embodiment has multiple mesh portions (the first mesh portion 12-1, the second mesh portion 12-2 and the third mesh portion 12-3), and the mesh portions have a special gradient mesh structure; besides, the lengths of the mesh portions are also specially designed. The above special structure designs can considerably increase the coefficient of performance (COP) and the maximal flow velocity of the regenerator 1, so the performance of the regenerator 1 can be further improved.

The embodiment just exemplifies the disclosure and is not intended to limit the scope of the disclosure. Any equivalent modification and variation according to the spirit of the disclosure is to be also included within the scope of the following claims and their equivalents.

It is worthy to point out that the performance of the currently available regenerators cannot be further improved due to the limits of the structures thereof, so the performance of Stirling coolers also cannot be further enhanced. On the contrary, according to one embodiment of the disclosure, the regenerator includes multiple mesh portions and these mesh portions have a special gradient mesh structure and the lengths of the mesh portions are also specially designed, which can significantly improve the coefficient of performance (COP) and the maximal flow velocity of the regenerator, so the performance of the regenerator can be enhanced.

Besides, according to one embodiment of the disclosure, the coefficient of performance and the maximal flow velocity of the regenerator can be dramatically improved, so the performance of the Stirling cooler adopting the regenerator can be also effectively improved. Therefore, the regenerator in accordance with the disclosure can definitely achieve great technical effects.

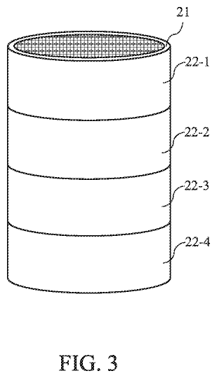

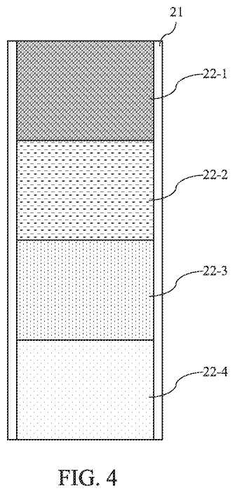

Please refer to FIG. 3 and FIG. 4, which are a stereoscopic view and a sectional view of a regenerator in accordance with a second embodiment of the disclosure respectively. As shown in FIG. 3, the regenerator 2 includes a hollow pipe body 21, a first mesh portion 22-1, a second mesh portion 22-2, a third mesh portion 22-3 and a fourth mesh portion 22-4. In the embodiment, the inside diameter of the hollow pipe body 21 is 5 mm and the outside diameter of the hollow pipe body 21 is 6 mm.

As shown in FIG. 4, the first mesh portion 22-1 may be disposed inside the hollow pipe body 21 and at the rear portion of the hollow pipe body 21.

The second mesh portion 22-2 may be disposed inside the hollow pipe body 21 and at the central portion of the hollow pipe body 21 and connected to the first mesh portion 22-1.

The third mesh portion 22-3 may be disposed inside the hollow pipe body 21 and at the central portion of the hollow pipe body 21 and connected to the second mesh portion 22-2.

The fourth mesh portion 22-4 may be disposed inside the hollow pipe body 21 and at the front portion of the hollow pipe body 21 and connected to the third mesh portion 22-3.

More specifically, the mesh number of the first mesh portion 22-1, the mesh number of the second mesh portion 22-2, the mesh number of the third mesh portion 22-3 and the mesh number of the fourth mesh portion 22-4 are increased from the rear portion of the hollow pipe body 21 to the front portion thereof. Besides, there is a highest common factor M3 of the mesh number of the first mesh portion 22-1, the mesh number of the second mesh portion 22-2, the mesh number of the third mesh portion 22-3 and the mesh number of the fourth mesh portion 22-4. In the embodiment, the highest common factor M3 is 50. In another embodiment, the highest common factor M1 may be other values (e.g. 25, 100 . . . ).

In the embodiment, the mesh number of the first mesh portion 22-1, the mesh number of the second mesh portion 22-2, the mesh number of the third mesh portion 22-3 and the mesh number of the fourth mesh portion 22-4 are increased from the rear portion of the hollow pipe body 21 to the front portion of the hollow pipe body 21 on a basis of an arithmetic sequence E2; the common difference of the arithmetic sequence E2 is the highest common factor M3. For example, the mesh number of the first mesh portion 22-1 is 200; the mesh number of the second mesh portion 22-2 is 250; the mesh number of the third mesh portion 22-3 is 350; the mesh number of the fourth mesh portion 22-4 is 400; the highest common factor M3 is 50.

In another embodiment, the difference between the second mesh portion 22-2 and the mesh number of the first mesh portion 22-1 is the highest common factor M3. The difference between the mesh number of the third mesh portion 22-3 and the mesh number of the second mesh portion 22-2 is the highest common factor M3. The difference between the mesh number of the fourth mesh portion 22-4 and the mesh number of the third mesh portion 22-3 is two times the highest common factor M3. For instance, the mesh number of the first mesh portion 22-1 is 250; the mesh number of the second mesh portion 22-2 is 250; the mesh number of the third mesh portion 22-3 is 300; the mesh number of the fourth mesh portion 22-4 is 400 (the highest common factor M1 is 50).

In still another embodiment, the difference between the second mesh portion 22-2 and the mesh number of the first mesh portion 22-1 is the highest common factor M3. The difference between the mesh number of the third mesh portion 22-3 and the mesh number of the second mesh portion 22-2 is two times the highest common factor M3. The difference between the mesh number of the fourth mesh portion 22-4 and the mesh number of the third mesh portion 22-3 is the highest common factor M3. For instance, the mesh number of the first mesh portion 22-1 is 250; the mesh number of the second mesh portion 22-2 is 300; the mesh number of the third mesh portion 22-3 is 400; the mesh number of the fourth mesh portion 22-4 is 450 (the highest common factor M3 is 50).

There is a highest common factor M4 of the length of the first mesh portion 22-1, the length of the second mesh portion 22-2, the length of the third mesh portion 22-3 and the length of the fourth mesh portion 22-4. In the embodiment, the highest common factor M4 is 5 mm. In another embodiment, the highest common factor M4 may be other values (e.g. 10 mm, 15 mm . . . ).

In the embodiment, the difference between the length of the second mesh portion 22-2 and the length of the first mesh portion 22-1 is the highest common factor M4, and the length of the second mesh portion 22-2, the length of the third mesh portion 22-3 and the length of the fourth mesh portion 22-4 are equal. For instance, the length of the first mesh portion 22-1 is 15 mm; the length of the second mesh portion 22-2, the length of the third mesh portion 22-3 and the length of the fourth mesh portion 22-4 are 10 mm (the highest common factor M4 is 5 mm).

In another embodiment, the length of the second mesh portion 22-2 is equal to the length of the first mesh portion 22-1. The difference between the length of the third mesh portion 22-3 and the length of the second mesh portion 22-2 is the highest common factor M4. The difference between the length of the fourth mesh portion 22-4 and the length of the third mesh portion 22-3 is the highest common factor M4. For example, the length of the first mesh portion 22-1 and the length of the second mesh portion 22-2 are 15 mm; the length of the third mesh portion 22-3 is 10 mm; the length of the fourth mesh portion 22-4 is 5 mm (the highest common factor M4 is 5 mm).

In still another embodiment, the difference between the length of the second mesh portion 22-2 and the length of the first mesh portion 22-1 is two times the highest common factor M4. The length of the third mesh portion 22-3 is equal to the length of the second mesh portion 22-2. The difference between the length of the fourth mesh portion 22-4 and the length of the third mesh portion 22-3 is the highest common factor M4. For example, the length of the first mesh portion 22-1 is 20 mm; the length of the second mesh portion 22-2 and the length of the third mesh portion 22-3 are 10 mm; the length of the fourth mesh portion 22-4 is 5 mm (the highest common factor M4 is 5 mm).

In still another embodiment, the mesh number of the first mesh portion 22-1, the mesh number of the second mesh portion 22-2, the mesh number of the third mesh portion 22-3 and the mesh number of the fourth mesh portion 22-4 may be equal.

As described above, the regenerator 2 of the embodiment also has multiple mesh portions (the first mesh portion 22-1, the second mesh portion 22-2, the third mesh portion 22-3 and the fourth mesh portion 22-4), and the mesh portions have a special gradient mesh structure; besides, the lengths of the mesh portions are also specially designed. The above special structure designs can considerably increase the coefficient of performance (COP) and the maximal flow velocity of the regenerator 1, so the performance of the regenerator 1 can be further improved.

In still another embodiment, the average size of the meshes in the central part of the first mesh portion 22-1 is larger than the average size of the meshes in the peripheral part of the first mesh portion 22-1. For example, the average size of the meshes in the peripheral part of the first mesh portion 22-1 is ¾ (or ⅘ ⅚, 6/7) of the average size of the meshes in the central part of the first mesh portion 22-1. The central part is a cylinder at the middle of the first mesh portion 22-1 and the circle center of the central part is the center of the first mesh portion 22-1. The peripheral part is a ring-shaped part around the central part; besides, the radius of the central part is a half of the radius of the first mesh portion 22-1. The second mesh portion 22-2, the third mesh portion 22-3 and the fourth mesh portion 22-4 also have the above structure. Which can effectively improve the performance of the regenerator 2.

The embodiment just exemplifies the disclosure and is not intended to limit the scope of the disclosure. Any equivalent modification and variation according to the spirit of the disclosure is to be also included within the scope of the following claims and their equivalents.

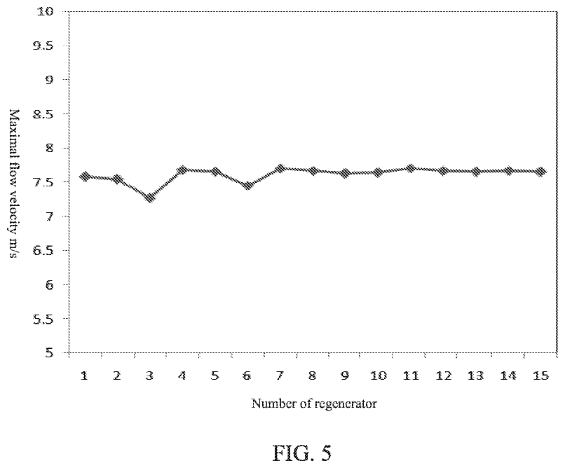

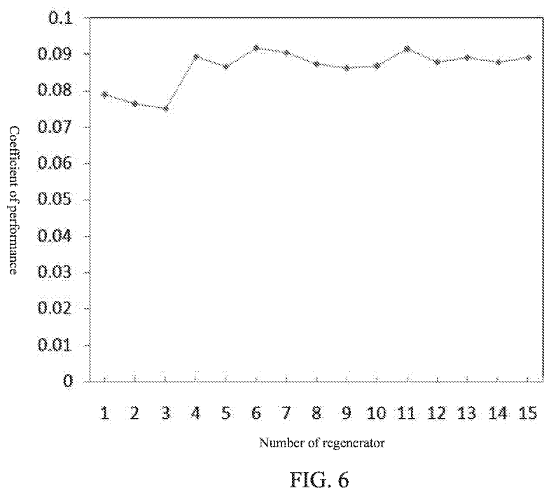

Please refer to FIG. 5 and FIG. 6, which are a simulation result of maximal flow velocity and a simulation result of coefficient of performance of a regenerator in accordance with a third embodiment of the disclosure.

TABLE 1

| Number of | | |
|---|---|---|
| regener- | | Mesh numbers of mesh |
| ator | Lengths of mesh portions | portions |
| 1 | 15 mm, 15 mm, 15 mm | #200, #250, #300 |
| 2 | 15 mm, 15 mm, 15 mm | #250, #300, #400 |
| 3 | 15 mm, 15 mm, 15 mm | #300, #400, #450 |
| 4 | 20 mm, 15 mm, 10 mm | #200, #250, #300 |
| 5 | 20 mm, 15 mm, 10 mm | #250, #300, #400 |
| 6 | 20 mm, 15 mm, 10 mm | #300, #400, #450 |
| 7 | 20 mm, 20 mm, 5 mm | #200, #250, #300 |
| 8 | 20 mm, 20 mm, 5 mm | #250, #300, #400 |
| 9 | 20 mm, 20 mm, 5 mm | #300, #400, #450 |
| 10 | 15 mm, 10 mm, 10 mm, 10 mm | #200, #250, #300, #400 |
| 11 | 15 mm, 10 mm, 10 mm, 10 mm | #250, #300, #400, #450 |
| 12 | 15 mm, 15 mm, 10 mm, 5 mm | #200, #250, #300, #400 |
| 13 | 15 mm, 15 mm, 10 mm, 5 mm | #250, #300, #400, #450 |
| 14 | 20 mm, 10 mm, 10 mm, 5 mm | #200, #250, #300, #400 |
| 15 | 20 mm, 10 mm, 10 mm, 5 mm | #250, #300, #400, #450 |

As shown in FIG. 5, the maximal flow velocity of each regenerator can be greater than 7 m/s, so the flow velocities of these regenerators can conform to actual requirements.

As shown in FIG. 6, the coefficient of performance of each regenerator can be greater than 0.07, so the performance of these regenerators can be obviously improved, in particular to the regenerators of No. 4-No. 15.

To sum up, according to one embodiment of the disclosure, the regenerator includes multiple mesh portions and these mesh portions have a special gradient mesh structure, which can significantly improve the coefficient of performance (COP) and the maximal flow velocity of the regenerator, so the performance of the regenerator can be enhanced.

Besides, according to one embodiment of the disclosure, the regenerator includes multiple mesh portions and the lengths of the mesh portions are specially designed, which can further improve the coefficient of performance and the maximal flow velocity of the regenerator, so the performance of the regenerator can be further enhanced.

Moreover, according to one embodiment of the disclosure, the coefficient of performance and the maximal flow velocity of the regenerator can be dramatically improved, so the performance of the Stirling cooler adopting the regenerator can be also effectively improved.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A regenerator, comprising:
a hollow pipe body;
a first mesh portion, disposed inside the hollow pipe body and at a rear portion of the hollow pipe body;
a second mesh portion, disposed inside and at a central portion of the hollow pipe body, and connected to the first mesh portion; and
a third mesh portion, disposed inside and at a front portion of the hollow pipe body, and connected to the second mesh portion;
wherein a mesh number of the first mesh portion, a mesh number of the second mesh portion and a mesh number of the third mesh portion are increased from the rear portion to the front portion of the hollow pipe body.

2. The regenerator of claim 1, wherein there is a highest common factor of the mesh number of the first mesh portion, the mesh number of the second mesh portion and the mesh number of the third mesh portion.

3. The regenerator of claim 2, wherein the mesh number of the first mesh portion, the mesh number of the second mesh portion and the mesh number of the third mesh portion are increased from the rear portion to the front portion of the hollow pipe body on a basis of an arithmetic sequence, wherein a common difference of the arithmetic sequence is the highest common factor.

4. The regenerator of claim 2, wherein a difference between the second mesh portion and the mesh number of the first mesh portion is the highest common factor, and a difference between the mesh number of the third mesh portion and the mesh number of the second mesh portion is two times the highest common factor.

5. The regenerator of claim 2, wherein a difference between the second mesh portion and the mesh number of the first mesh portion is the is two times the highest common factor, and a difference between the mesh number of the third mesh portion and the mesh number of the second mesh portion is the highest common factor.

6. The regenerator of claim 1, wherein a length of the first mesh portion, a length of the second mesh portion and a length of the third mesh portion are equal.

7. The regenerator of claim 1, wherein there is a highest common factor of a length of the first mesh portion, a length of the second mesh portion and a length of the third mesh portion.

8. The regenerator of claim 7, wherein a length of the first mesh portion, a length of the second mesh portion and a length of the third mesh portion are decreased on a basis of an arithmetic sequence.

9. The regenerator of claim 7, wherein a common difference of the arithmetic sequence is the highest common factor.

10. The regenerator of claim 7, wherein the length of the first mesh portion is equal to the length of the second mesh portion, and the length of the third mesh portion is the highest common factor.

11. A regenerator, comprising:
a hollow pipe body;
a first mesh portion, disposed inside the hollow pipe body and at a rear portion of the hollow pipe body;
a second mesh portion, disposed inside and at a central portion of the hollow pipe body, and connected to the first mesh portion; and
a third mesh portion, disposed inside and at the central portion of the hollow pipe body, and connected to the second mesh portion; and
a fourth mesh portion, disposed inside and at a front portion of the hollow pipe body, and connected to the third mesh portion;
wherein a mesh number of the first mesh portion, a mesh number of the second mesh portion, a mesh number of the third mesh portion and a mesh number of the fourth mesh portion are increased from the rear portion to the front portion of the hollow pipe body.

12. The regenerator of claim 10, wherein there is a highest common factor of the mesh number of the first mesh portion, the mesh number of the second mesh portion, the mesh number of the third mesh portion and the mesh number of the fourth mesh portion.

13. The regenerator of claim 12, wherein the mesh number of the first mesh portion, the mesh number of the second mesh portion, the mesh number of the third mesh portion and the mesh number of the fourth mesh portion are increased from the rear portion to the front portion of the hollow pipe body on a basis of an arithmetic sequence, wherein a common difference of the arithmetic sequence is the highest common factor.

14. The regenerator of claim 12, wherein a difference between the second mesh portion and the mesh number of the first mesh portion is the highest common factor, a difference between the mesh number of the third mesh portion and the mesh number of the second mesh portion is the highest common factor, and a difference between the mesh number of the fourth mesh portion and the mesh number of the third mesh portion is two times the highest common factor.

15. The regenerator of claim 12, wherein a difference between the second mesh portion and the mesh number of the first mesh portion is the highest common factor, a difference between the mesh number of the third mesh portion and the mesh number of the second mesh portion is two times the highest common factor, and a difference between the mesh number of the fourth mesh portion and the mesh number of the third mesh portion is the highest common factor.

16. The regenerator of claim 11, wherein a length of the first mesh portion, a length of the second mesh portion, a length of the third mesh portion and a length of the fourth mesh portion are equal.

17. The regenerator of claim 11, wherein there is a highest common factor of a length of the first mesh portion, a length of the second mesh portion, a length of the third mesh portion and a length of the fourth mesh portion.

18. The regenerator of claim 17, wherein a difference between the length of the second mesh portion and the length of the first mesh portion is the highest common factor, and the length of the second mesh portion, the length of the third mesh portion and the length of the fourth mesh portion are equal.

19. The regenerator of claim 17, wherein the length of the second mesh portion and the length of the first mesh portion are equal, a difference between the length of the third mesh portion and the length of the second mesh portion is the highest common factor, and a difference between the length of the fourth mesh portion and the length of the third mesh portion is the highest common factor.

20. The regenerator of claim 17, wherein a difference between the length of the second mesh portion and the length of the first mesh portion is two times the highest common factor, the length of the third mesh portion and the length of the second mesh portion are equal, and a difference between the length of the fourth mesh portion and the length of the third mesh portion is the highest common factor.
